(19) United States
(12) Patent Application Publication
(10) Pub. No.: US 2005/0144535 A1
(43) Pub. Date: Jun. 30, 2005

(54) Process and apparatus of notifying a reference model of the occurrence of an event in a monitored interface

(76) Inventors: Daniel J. Murray, Rochester, MN (US); George W. Gorman, Rochester, MN (US)

Correspondence Address: Leo J. Peters;LSI Logic Corporation, 1621 Barber Lane, MS D-106, Milpitas, CA, 95035, US

(21) Appl. No.: 10/734,325

(22) Filed: Dec. 12, 2003

(51) Int. Cl. G06F 11/00

(52) U.S. Cl. 714/47

(57) ABSTRACT

Data concerning an occurrence of an interface event affecting a device under test is interpreted by a reference model having a listener registered on a list with the monitor and having like inheritance to the listener interface. The monitor monitors for the occurrence of the interface event and supplies data to the listener in a structure defined by the monitor. An event handler associated with the listener generates a private data structure based on the monitor's data structure concerning the interface event. The private data structure is supplied to the reference model.

### FIELD OF THE INVENTION

This invention relates to event monitoring, and particularly to monitoring events in a hardware interface.

### BACKGROUND OF THE INVENTION

Event monitoring is a well-known technique used when testing a device. FIG. 1 illustrates a typical environment for monitoring a device under test (DUT) 10. A reference model 12 “listens” to interface events that are detected by a monitor 14 coupled to a bus interface 16 which in turn is coupled to DUT 10. Monitor 14 monitors interface events in interface 16 and collects data concerning those events. In a typical test environment, monitor 14 and bus interface 16 are part of a bus interface transactor 18, and several bus interface transactors 18, 18′, each having a monitor 14, 14′ and bus interface 16, 16′ might monitor a respective bus interface for given interface events. DUT 10 is responsive to, and provides responses to, bus interface 16. Reference model 12 monitors the activities in both DUT 10 and interface 16.

As used herein, an “interface event” is an event occurring in an interface 16 in association with DUT 10. A “public event” is a notification by the monitor of an interface event. For example, a rising edge of a pulse signal in the bus interface might be an interface event which a public event (notification) might be invoked. A “public data structure” denotes a data structure from the monitor associated with an interface event. For example, a monitor monitoring messages on a read/write interface might identify whether the interface message is a read or a write message, its address and data. The public data structure describes the nature of the interface event. A “public method” is a predetermined procedure provided by a monitor for use by a reference model.

There are two principal approaches to monitoring DUT 10 and interface 16. In a first approach, the monitor 14 that is watching interface 16 creates a public event and a public data structure upon sensing an interface event being monitored. Each reference model 12 that has a pointer to monitor 14 responds to the public event (that an interface event has occurred) to create a mirror event that mirrors the interface event. When the reference model's mirror event occurs, the reference model copies the public data structure from the monitor to its own area and uses the public data structure to either predict or check the behavior of DUT 10.

The second approach is slightly different from the first. As in the first approach, each reference model 12 that has a pointer to the monitor 14 creates a mirror event that mirrors the interface event. When the interface event occurs, the mirror event in the reference model occurs and the reference model calls a public method in the monitor to retrieve the data structure associated with the event to predict or check the DUT's behavior.

There are several disadvantages to these prior approaches and there are also problems that these approaches do not solve well.

The first approach disregards data encapsulation which is a fundamental feature in Object Oriented Programming (OOP). In OOP, an object should not expose its internal data for other objects to directly access. Otherwise, there is a risk of data corruption. Instead, in OOP, methods should be provided to access the data without exposing internal data to other objects. Encapsulation maximizes reusability and eliminates possible erroneous modifications of an object's internal data structures.

Another problem with these approaches is that the reference model might inadvertently sample the monitor's data structure when it is not valid. The data structure is often valid only on the clock cycle (tick) during which the event occurs. However, prior monitoring techniques do not strictly enforce that condition.

In both of the prior approaches, multiple events during the same simulation tick could cause data structures to be overwritten before they are sampled, thereby causing a loss of data. Moreover, both approaches create an extra event which could lead to reduced performance in simulation. Also, both approaches have problems scaling if a reference model is listening to the same event from a list of monitors where the list is not a determinable size.

The present invention standardizes a manner in which interface monitors can notify a reference model that an interface event has occurred on a hardware interface, and is applicable to more general cases where any unit or struct (string of code) needs to be notified about events detected by another unit or struct.

### SUMMARY OF THE INVENTION

In a first embodiment of the invention, data concerning an occurrence of an interface event affecting a device is interpreted by a reference model. The reference model is configured to like inherit at least a portion of the monitor. The monitor is operated to detect the occurrence of the interface event and supplies data to the reference model concerning the occurrence of the interface event. The supplied data has a structure defined by the monitor. The data is re-formatted for interpretation by the reference model.

In some embodiments, the reference model is registered with the monitor on request from the reference model. A listener interface is established by the monitor, and a listener is configured to like inherit from the listener interface. A pointer is entered to a list accessible to the monitor.

Preferably, each listener includes an event handler. On detection of an interface event, the monitor generates a data structure for all listeners, and the respective event handlers generate private data structures for the respective reference models.

A given monitor may notify each of a plurality of reference models of the occurrence of a given interface event through respective pointers and listeners. A given reference model may include a plurality of listeners associated with each of a plurality of monitors, each listener being of like inheritance to the respective listener interface.

In other embodiments, a computer readable program comprises computer readable code that is stored in the monitor and reference model to carry out the process.

### BRIEF DESCRIPTION OF THE DRAWINGS

FIGS. 1 and 2 block diagrams of typical monitor systems and are illustrative of the environment of the present invention.

FIGS. 3 and 4 are a block diagrams of different configurations of monitors and reference models in accordance with the present invention.

FIG. 5 is a flowchart of the process of registering a reference model with a monitor in accordance with an embodiment of the present invention.

FIG. 6 is a flowchart of the process of notifying a reference model of an interface event by a monitor in accordance with an embodiment of the present invention.

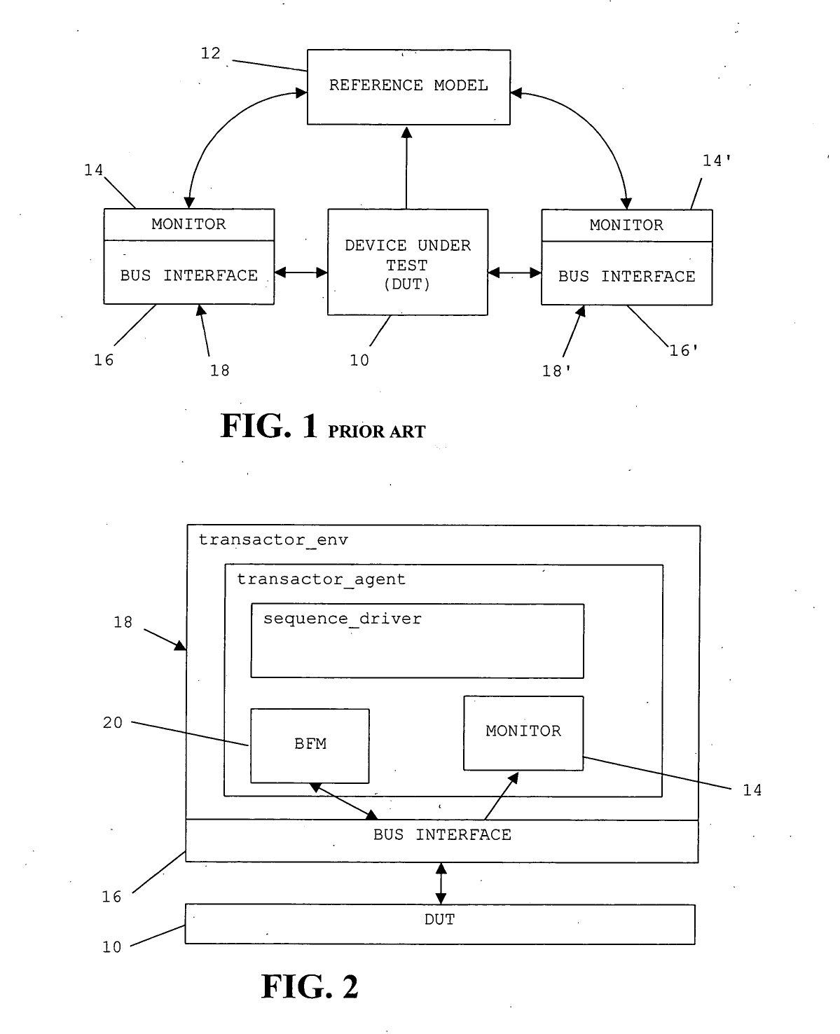

### DETAILED DESCRIPTION OF THE PREFERRED EMBODIMENTS

FIG. 2 illustrates a monitoring environment according to an embodiment of the present invention employing a transactor 18 having a monitor 14 included in a Verisity e Verification Component (eVC). Transactor 18 interacts with external bus interface 16 coupled to the device under test 10. Monitor 14 detects interface events occurring on the respective interface 16 and collects data that describes the interface events. A bus functional model (BFM) 20 operates bus interface 16 to perform tests on device 10. One or more reference models 12 (not shown in FIG. 2) are coupled to transactor 18 to automatically check the behavior of DUT 10 based on input and output interface events occurring on its external interfaces 16. Each reference model uses the events and data structures provided by monitors 14, rather than monitoring the interface itself.

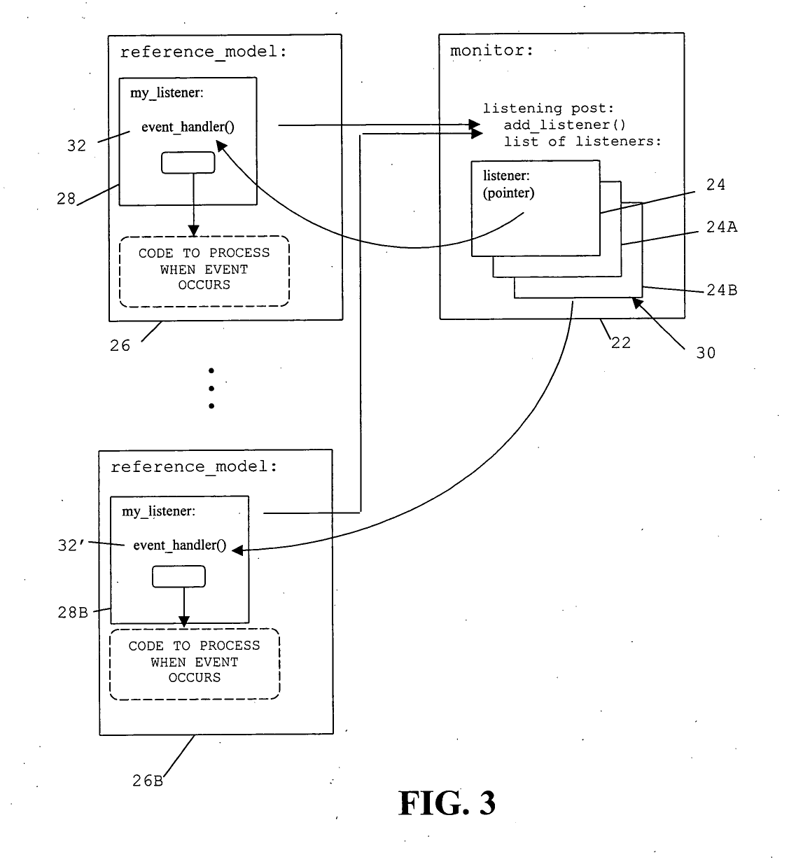

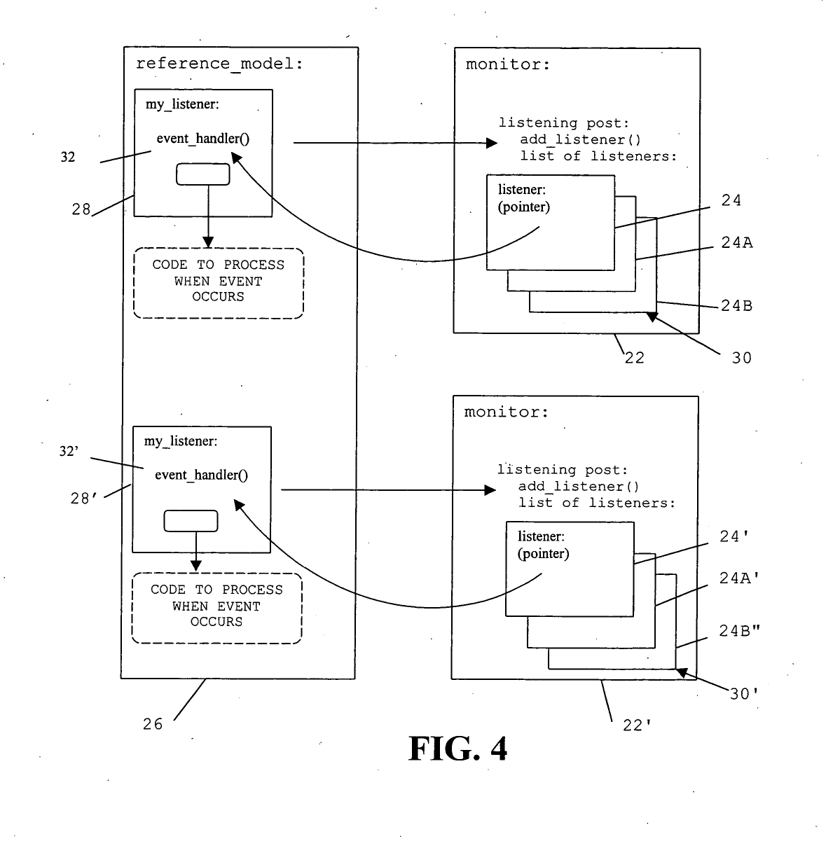

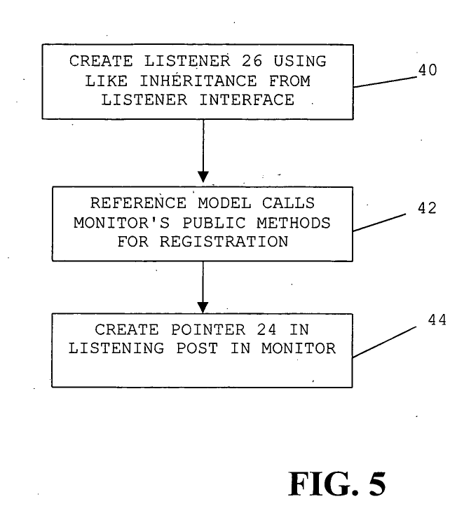

FIGS. 3 and 4 illustrate two of many possible environments of monitors 22 and reference models 26 in accordance with the present invention. Each monitor 22 according to the present invention has a listening post that includes a list 30 of listener entries 24, 24A, 24B together with public methods that perform various functions. One public method permits a reference model 26 to register with the monitor by creating a new entry 24. Another public method permits a reference model to remove its associated entry 24 from the listening post to thereby remove its registration. The registration process is shown in greater detail in FIG. 5.

Each listener entry 24 is associated with a respective listener 28 in a reference model 26 to provide a data structure to the respective reference model, the data structure being associated with an interface event monitored by the monitor. Monitor 22 monitors interface events on a respective bus interface 16 coupled to a device under test 10 (FIG. 2). Upon the occurrence of an interface event, the monitor provides the data structure concerning the event to event handlers 32 of each listener 28. The event handlers are methods invoked by the monitor to generate respective private data structures based on the monitor's data structure concerning the event. The private data structures are created by the respective listeners 28 in the respective reference models 26 registered on the private list of listener entries 24.

When a reference model is registered with a monitor, its listener 28 is derived from the listener interface in transactor 18 (FIG. 2) declared by the monitor. The listener is created using like inheritance from the listener interface. Each event handler re-formats the data structure from the monitor to the form and structure associated with the respective reference model. Since the respective listener 28 is instantiated in the reference model, it has access to information in the reference model.

FIG. 3 illustrates an environment where a single monitor 22 provides notification to plural reference models 26, . . . , 26B, each having a listener 28, . . . , 28B registered with monitor 22. Monitor 22 has a list 30 of listener units 24, . . . , 24B that point to respective listeners 29, . . . , 28B. Upon detection of an interface event, monitor 22 issues a data structure to the event handlers 32. Each event monitor issues a copy of the data structure to the respective listeners 28, . . . , 28B. Each respective listener 28 then re-formats the data structure to the requirements of the respective reference model.

FIG. 4 illustrates an environment where a single reference model 26 has plural listeners 28, 28′, each receiving data concerning interface events from different monitors 22, 22′. In this case, reference model 26 receives and interprets data from two monitors to predict or check the behavior of the device under test. FIG. 4 demonstrates how a single reference model receives interface event data from plural monitors using plural listeners 28, whereas FIG. 3 demonstrates how a single monitor can supply interface event data to plural reference models using plural listener entries 24 in the list of listener entries. Those skilled in the art will recognize the environments of FIGS. 3 and 4 are illustrative of numerous environments to which the present invention may be applied.

Initially, the list of listener entries 24 in monitor 22 is empty. A public method in monitor 22 permits reference models 26 to register a respective listener 28 to the list 30 of listener entries 24. Another public method permits any registered reference model to de-register its listener 28 by removing the respective listener entry 24 from list 30. When a reference model 26 desires to register its listener 28 to the list of listener entries 24, the reference model uses the public methods in monitor 22 to cause monitor 22 to add a pointer to its listener to list 30 in monitor 22 as a new listener entry 24. Thus, the listener entry 24 is assigned exclusively to the respective reference model.

Upon assignment of a reference model to a listener entry, monitor 22 establishes a listener interface between the monitor and reference model. The reference model creates a listener 28 using like inheritance from the listener interface so that the communication characteristics of listener 28 are derived from the listener interface. Thus, listener 28 has “like inheritance” from the listener interface. Consequently, listener 28 uses the same data structure (fields) created by the monitor.

In a similar manner, when a reference model 26 desires to delete its listener 28 from the list of listener entry 24, it uses the public methods to delete its entry from the list.

One feature of the registration scheme of the present invention is that the number of reference models (listeners) registered with a monitor is limitless, yet the length of the list is determinable. Consequently, event monitoring is scalable.

The registration process is more fully illustrated in the flowchart of FIG. 5. At step 40, the reference model creates a listener 28 using like inheritance of the listener interface established by the monitor. Consequently, the newly-created listener 28 will employ an identical data structure (identical fields, etc.) as the listener interface. At step 42, a reference model 26 initiates the registration process by calling public methods in selected monitors 22. At step 44, the public methods in the selected monitors create respective listener entries 24 in the listening posts. The listener entry is a pointer that points to listener 28 in the reference model. Thus, each listener entry 24 in list 30 is a pointer to the respective listener 28. If a reference model is registered with plural monitors, it will have a plurality of listeners 28, each associated with a respective listener entry 24 in each of the plurality of monitors.

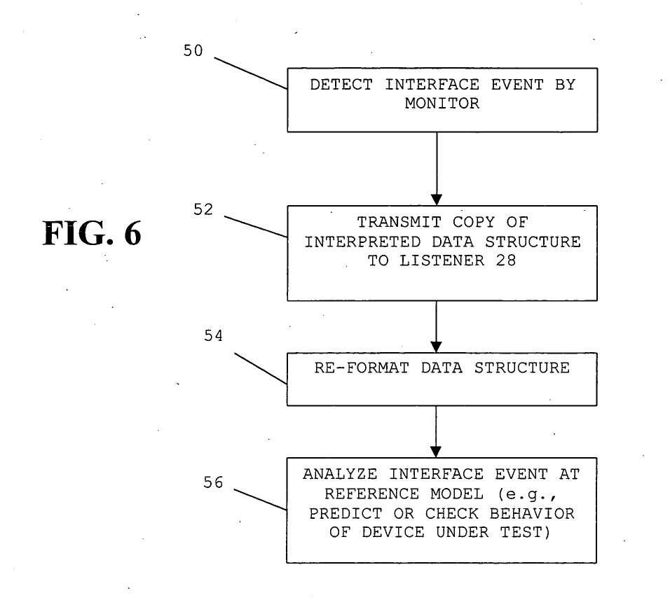

FIG. 6 is a flowchart of the process of notifying a reference model of the occurrence of an interface event. At step 50, an interface event is detected by monitor 14. At step 52, the monitor provides a data structure to the respective listener 28 previously registered with the monitor's listening post in the list 30 of listeners. At step 54, the event handler 32 re-formats the data structure for the reference model. At step 56 the reference model analyzes the interpreted data structure, such as by predicting or checking behavior of the device under test.

In preferred embodiments, the present invention is carried out using a computer readable program having code in the monitor and the reference model that creates re-usable and scalable hardware verification environments.

The present invention thus provides a monitoring technique for notification of an interface event to a reference model for a device under test that maintains data encapsulation needed for object oriented programs. Because the listeners in the reference models like inherit the listener interface from the respective monitor, the units are fully and automatically compatible. Moreover, any chance that the reference model might inadvertently sample the monitor's data structure when it is not valid is precluded because the monitor supplies copies of the interpreted data structures to the reference models that are collected during an interface event.

A monitor might provide data structures concerning plural interface events being monitored by the monitor. Because the monitor initiates the process of supplying data structures to the reference models, the data structures are effectively protected from being overwritten due to multiple interface events occurring during the same simulation tick.

Although the present invention has been described with reference to preferred embodiments, workers skilled in the art will recognize that changes may be made in form and detail without departing from the spirit and scope of the invention.

1. A process of supplying data concerning an occurrence of an interface event affecting a device to at least one reference model having at least one listener, comprising steps of:
operating a monitor to detect the occurrence of the interface event;
maintaining a list of listeners accessible to the monitor; and
supplying data from the monitor to the listeners on the list in response to the occurrence of the interface event for use by the respective reference model.

2. The process of claim 1, further comprising:
registering the listener with the monitor.

3. The process of claim 1, wherein the listener is instantiated in the reference model, the process further comprising:
configuring the listener to like inherit a listener interface,
transmitting a registration request to the monitor, and
entering a pointer to the listener in the list in response to the request.

4. The process of claim 3, further comprising:
generating a first data structure by the monitor in response to the occurrence of an interface event, and
generating a private data structure for the reference model based on the first data structure and an event handler.

5. The process of claim 1, further comprising:
generating a first data structure by the monitor in response to the occurrence of an interface event, and
generating a private data structure for the reference model based on the first data structure and an event handler.

6. The process of claim 1, wherein a plurality of monitors are operated for the occurrence of respective interface events, and the reference model is configured to perform procedures inherited from each monitor, whereby each monitor supplies data to the reference model concerning the respective interface event in a structure derived from the respective monitor, and the reference model interprets the data.

7. The process of claim 6, wherein a plurality of listeners are instantiated in the reference model, the process further comprising:
configuring the respective listener to like inherit the respective listener interface,
transmitting a registration request to each monitor, and
in each monitor, entering a pointer in a list accessible to the respective monitor.

8. The process of claim 1, wherein a plurality of reference models are each configured to perform procedures inherited from the monitor, whereby the monitor supplies data to the plurality of reference models concerning the interface event in a structure derived from the monitor, and each reference model interprets the data.

9. The process of claim 1, further comprising:
interpreting the data by the reference model.

10. The process of claim 1, wherein the listener includes an event handler and the process further comprises:
generating a first data structure by the monitor in response to the occurrence of an interface event, and
generating a private data structure for the reference model based on the first data structure and the event handler.

11. Apparatus comprising:
a listener interface for a monitor monitoring the occurrence of interface events affecting a device;
at least one listener associated with a respective reference model, each at least one listener being responsive to a first data structure from the monitor for re-formatting the first data structure to a private data structure for the respective reference model, the at least one listener having like inheritance to the listener interface; and
a listening post associated with the monitor having a pointer pointing to the at least one listener.

12. The apparatus of claim 11, wherein the listening post has a plurality of pointers associated with respective listeners in respective reference models, the monitor providing the first data structure to all of the listener entries,
and an event handler associated with each listener and responsive to the first data structure provide the respective private data structure to the associated reference model concerning the interface event.

13. The apparatus of claim 11, wherein the listening post further includes processes for registering and/or de-registering listeners.

14. A monitor and a reference model storing respective portions of a program for controlling the monitor to supply data to the reference model concerning an occurrence of an interface event affecting a device, the program comprising:
code for operating the monitor for the occurrence of an interface event;
code for maintaining a list of listeners accessible to the monitor; and
code for operating the monitor to respond to the occurrence of an interface event to supply data to the listeners on the list in response to the occurrence of the interface event for use by the respective reference model.

15. The apparatus of claim 14, further comprising:
code for configuring the listener to like inherit a listener interface,
code for causing the reference model to transmit a registration request to the monitor, and
code for entering a pointer in the list in response to the request.

16. The apparatus of claim 15, further comprising:
code for causing the monitor to generate a first data structure in response to the occurrence of an interface event, and
code for causing an event handler to generate the private data structure based on the first data structure.

17. The apparatus of claim 14, further comprising:
code for causing the monitor to generate a first data structure in response to the occurrence of an interface event, and
code for causing an event handler to generate the private data structure based on the first data structure.

18. The apparatus of claim 14, wherein a plurality of monitors are operated for the occurrence of respective interface events, whereby each monitor is programmed to supply data to the reference model concerning the respective interface event in a structure defined by the respective monitor.

19. The apparatus of claim 14, wherein a plurality of reference models are each configured to receive data from the monitor, whereby the monitor supplies data to the plurality of reference models concerning the interface event in a structure defined by the monitor.

20. The apparatus of claim 14, further comprising:
code for causing the reference model to interpret the data.
